(19) United States
(12) Patent Application Publication
(10) Pub. No.: US 2022/0031553 A1
(43) Pub. Date: Feb. 3, 2022

(54) WALKING AID

(71) Applicant: MENG-CHUN WANG, Taichung City (TW)

(72) Inventor: MENG-CHUN WANG, Taichung City (TW)

(21) Appl. No.: 16/942,522

(22) Filed: Jul. 29, 2020

(51) Int. Cl. A61H 3/04; G05D 1/02

(52) U.S. Cl. CPC A61H 3/04; G05D 2201/0206; A61H 2003/043; G05D 1/021

(57) ABSTRACT

A walking aid is provided, including a frame body, a connecting assembly and two first adjusting assemblies. The frame body includes two first legs which are parallel to each other and two second legs which are parallel to each other. The connecting assembly includes two first cross bars and two second cross bars, each said first cross bar is further pivoted to one of the two second legs, and the two second cross bars are respectively pivoted to and between one of the two first legs and one of the two second legs. Each said first adjusting assembly includes a first abutting assembly and a second abutting assembly, and each said first abutting assembly is disposed on one of the two first legs and movable to be located in a first position or a second position.

### BACKGROUND OF THE INVENTION

### Field of the Invention

The present invention relates to a walking aid.

### Description of the Prior Art

Generally, a walking aid has four legs which have a greater distance therebetween, so it can effectively help the elderly or people who are rehabilitating to walk with greater side support. This type of walking aid is disclosed in TWM481724. To let a user to go up or down the stairs conveniently, a walking aid with retractable legs is invented, and rectangular rod can abut against different stairs through extending or retracting the legs. This type of walking aid is disclosed in TWM540645.

However, it is difficult to operate the retractable legs because the user needs to bend down to grip and retract the legs. Therefore, for users whose lower body cannot move normally, it is inconvenient for them to operate, and they may fall over accidentally.

The present invention has arisen to mitigate and/or obviate the afore-described disadvantages.

### SUMMARY OF THE INVENTION

The major object of the present invention is to provide a walking aid, in which relative heights of two first legs and two second legs can be quickly adjusted for a user to go up or down the stairs or on an uneven ground.

To achieve the above and other objects, a walking aid is provided, including a frame body, a connecting assembly and two first adjusting assemblies. The frame body includes two first legs which are parallel to each other and two second legs which are parallel to each other, and each said first leg includes a first pivoting portion. The connecting assembly includes two first cross bars and two second cross bars, each said first cross bar includes a second pivoting portion which is pivoted to the first pivoting portion, each said first cross bar is further pivoted to one of the two second legs, and the two second cross bars are respectively pivoted to and between one of the two first legs and one of the two second legs. Each said first adjusting assembly includes a first abutting assembly and a second abutting assembly, each said first abutting assembly is disposed on one of the two first legs and movable to be located in a first position or a second position, and each said second abutting assembly is disposed on one of the two first cross bars. When the two first abutting assemblies are located in the first position, the two first abutting assemblies respectively abut against the two second abutting assemblies, and the two first pivoting portions are unrotatable relative to the two second pivoting portions; when the two first abutting assemblies are located in the second position, the two first abutting assemblies are disengaged from the two second abutting assemblies, and the two first pivoting portions are rotatable relative to the two second pivoting portions.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferred embodiment of the present invention;

FIG. 2 is a breakdown view of the preferred embodiment of the present invention;

FIGS. 3 and 4 are partially breakdown views of the preferred embodiment of the present invention;

FIG. 5 is another partially breakdown view of the preferred embodiment of the present invention;

FIG. 6 is a cross-sectional view of the preferred embodiment of the present invention;

FIG. 7 is a partially enlarged view of FIG. 6; FIG. 8 is another cross-sectional view of the preferred embodiment of the present invention;

FIG. 9 is a partially enlarged view of FIG. 8;

FIG. 10 is still another cross-sectional view of the preferred embodiment of the present invention; and

FIGS. 11 to 15 are drawings showing the preferred embodiment of the present invention in use.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

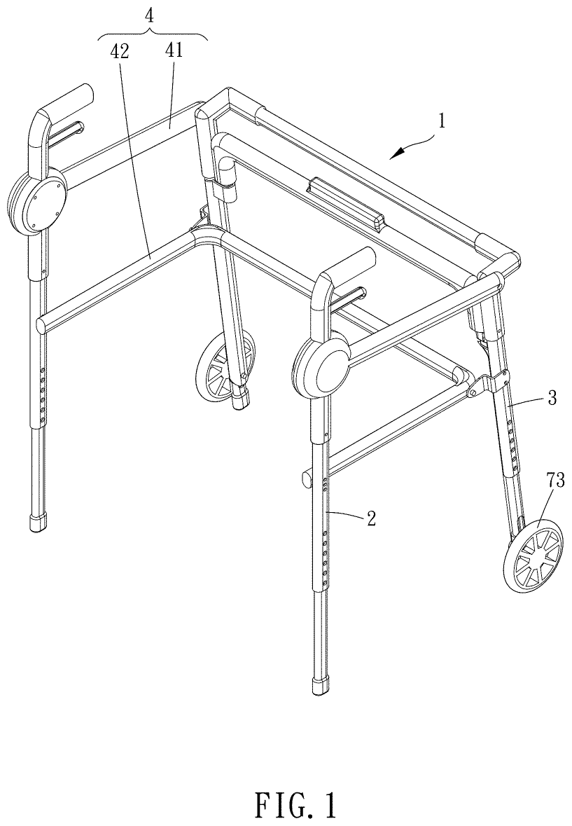

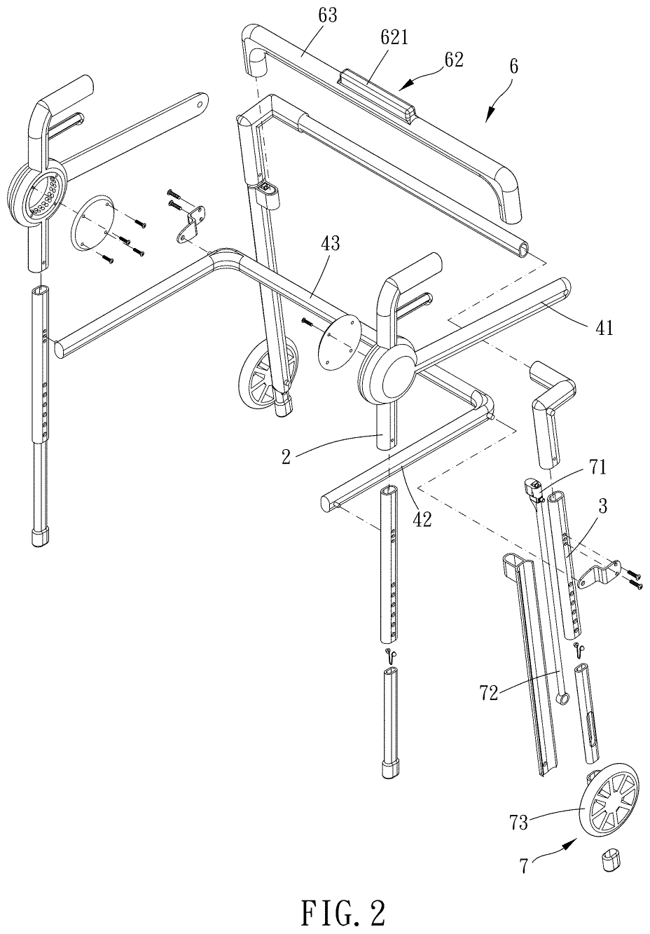

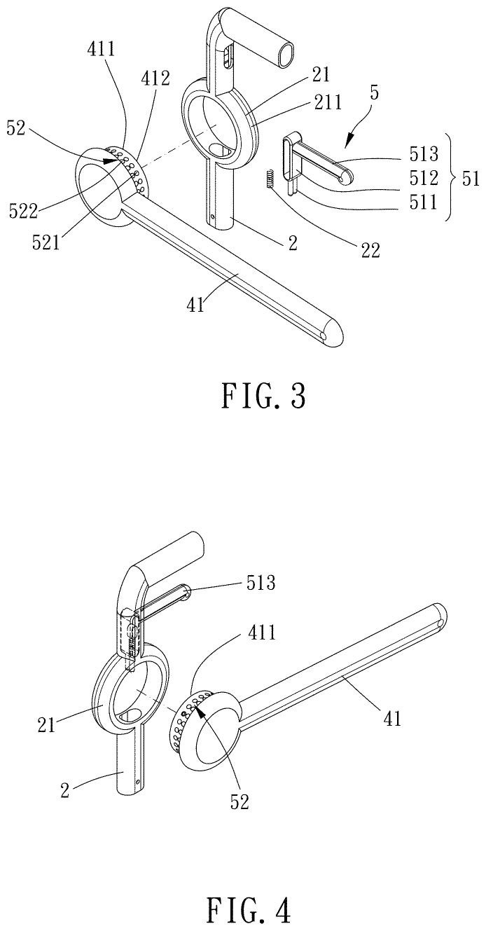

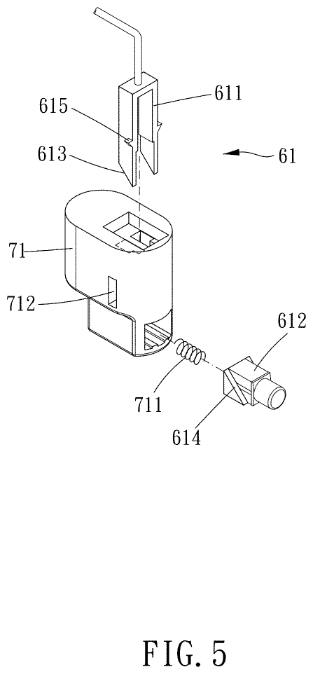

Please refer to FIGS. 1 to 15 for a preferred embodiment. A walking aid includes a frame body 1, a connecting assembly 4 and two first adjusting assemblies 5.

The frame body 1 includes two first legs 2 which are parallel to each other and two second legs 3 which are parallel to each other, and each said first leg 2 includes a first pivoting portion 21.

The connecting assembly 4 includes two first cross bars 41 and two second cross bars 42, each said first cross bar 41 includes a second pivoting portion 411 which is pivoted to the first pivoting portion 21, each said first cross bar 41 is further pivoted to one of the two second legs 3, and the two second cross bars 42 are respectively pivoted to and between one of the two first legs 2 and one of the two second legs 3.

Each said first adjusting assembly 5 includes a first abutting assembly 51 and a second abutting assembly 52, each said first abutting assembly 51 is disposed on one of the two first legs 2 and movable to be located in a first position or a second position, and each said second abutting assembly 52 is disposed on one of the two first cross bars 41.

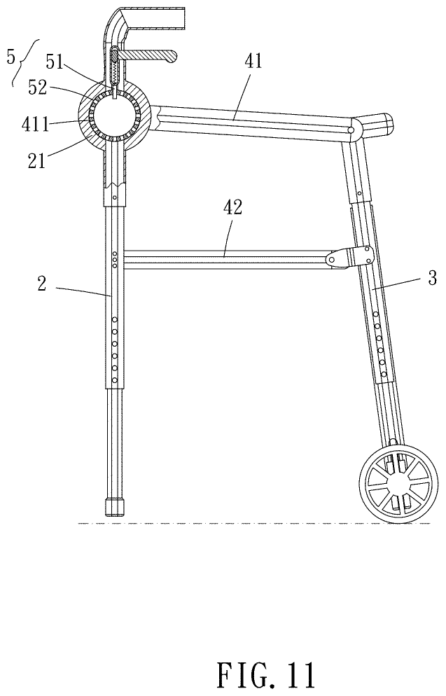

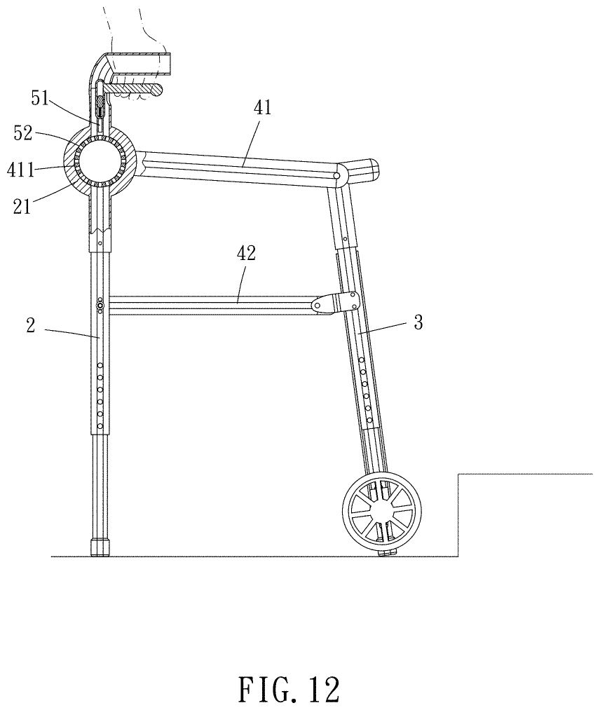

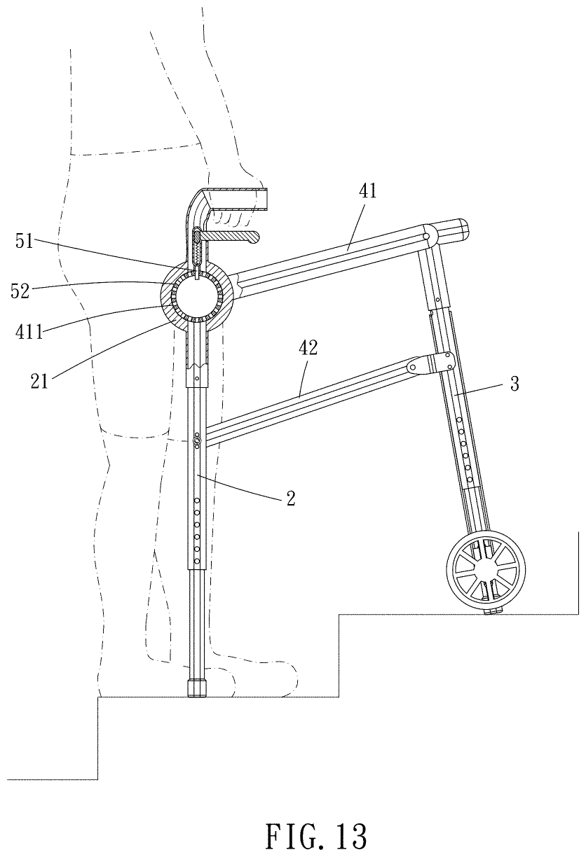

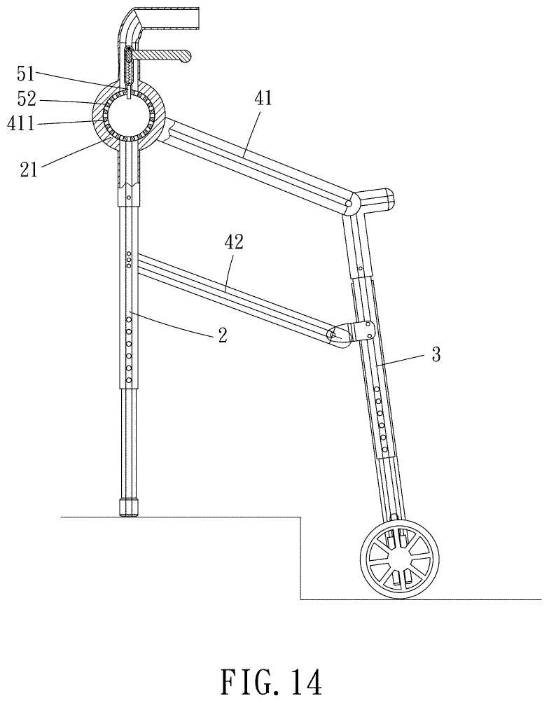

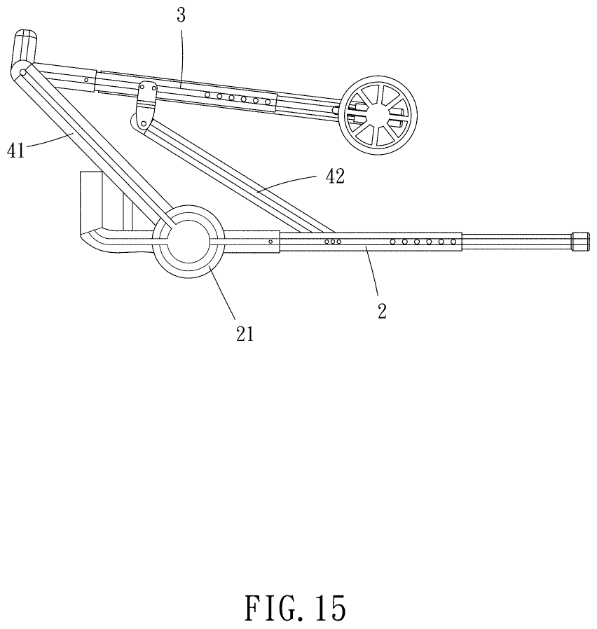

When the two first abutting assemblies 51 are located in the first position, the two first abutting assemblies 51 respectively abut against the two second abutting assemblies 52 (as shown in FIG. 11), and the two first pivoting portions 21 are unrotatable relative to the two second pivoting portions 411; when the two first abutting assemblies 51 are located in the second position, the two first abutting assemblies 51 are disengaged from the two second abutting assemblies 52 (as shown in FIG. 12), and the two first pivoting portions 21 are rotatable relative to the two second pivoting portions 411. Therefore, the two first cross bars 41 and the two second cross bars 42 can swing relative to the two first legs 2 and the two second legs 3 so as to adjust relative heights of the two first legs 2 and the two second legs 3. After the adjustment, the two first abutting assemblies 51 can be moved to the first position to be used when going up or down slopes or stairs (as shown in FIGS. 13 and 14) or to be folded for storage (as shown in FIG. 15), so the user does not need to crouch down or bend down to adjust the relative heights of the two first legs 2 or the two second legs 3, and the two first cross cars 41 and the two second cross bars 42 are swingable relative to the two first legs 2 and the two second legs 3 to be quickly adjusted. Preferably, a linkage rod 43 integrally extends from the two second cross bars 42, and the linkage rod 43 is laterally connected to the two second cross bars 42 to make the two second cross bars 42 to be movable with each other so that the two first legs 2, the two first cross bars 41 and the two second cross bars 42 form two four-linkage structures which are movable with each other.

Specifically, each said first abutting assembly 51 includes a first abutting member 511 which is movably disposed on the first pivoting portion 21, each said second abutting assembly 52 includes a plurality of second abutting members 521 which are disposed on the second pivoting portion 411, and when each said first abutting assembly 51 is located in the first position, the first abutting member 511 of each said first abutting assembly 51 is abuttable against one of the plurality of second abutting members 521 of one of the two second abutting assemblies 52. In this embodiment, the plurality of second abutting members 521 of each said second abutting assembly 52 are annularly arranged on a plurality of recesses 522 of an exterior circumferential wall of one of the two second pivoting portions 411, and the first abutting member 511 is insertable into one of the plurality of recesses 522 to prevent the first pivoting portion 21 from rotating relative to the second pivoting portion 411.

In addition, each said first pivoting portion 21 is an exterior annular member 211, each said second pivoting portion 411 is a pivoting block 412 which is pivoted to and within the exterior annular member 211, and the plurality of recesses 522 of each said second abutting assembly 52 are disposed on an exterior circumferential wall of the pivoting block 412, so the two second abutting members 511 and the plurality of recesses 52 will not be exposed outside to prevent from being hit by foreign objects.

In this embodiment, the first abutting assembly 51 includes a first sliding member 512 and a first adjusting member 513, the first sliding member 512 is co-movably connected to and between the first abutting member 511 and the first adjusting member 513, the first sliding member 512 is arranged on the first leg 2, the first leg 2 further has a first elastic member 22, the first elastic member 22 normally biases the first sliding member 512 to move toward the first position, and the first adjusting member 513 is exposed within the first leg 2, so the user can control the two first sliding members 512 and the two first abutting members 511 to move through controlling the two first adjusting members 513.

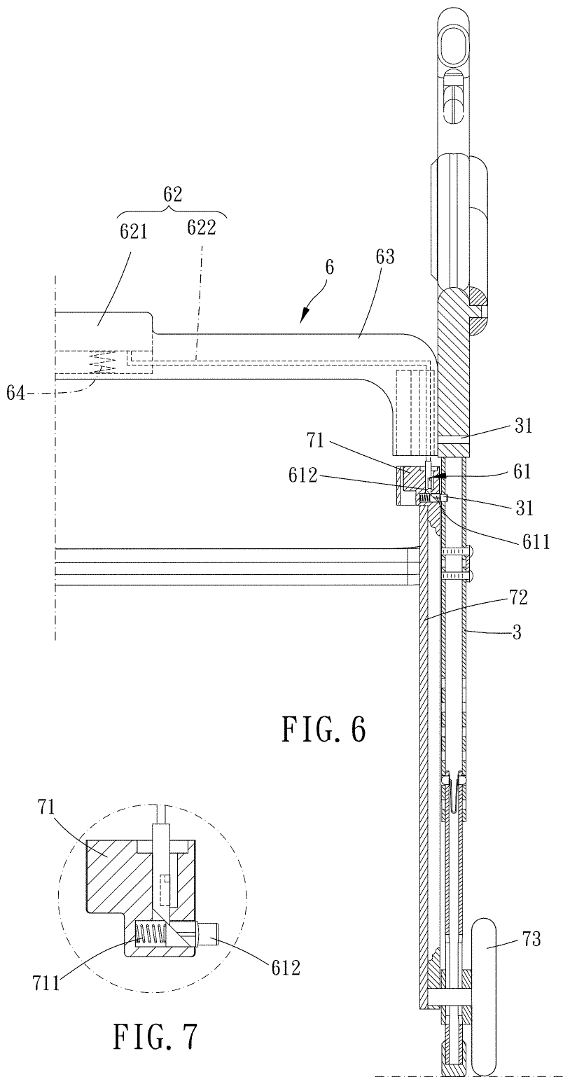

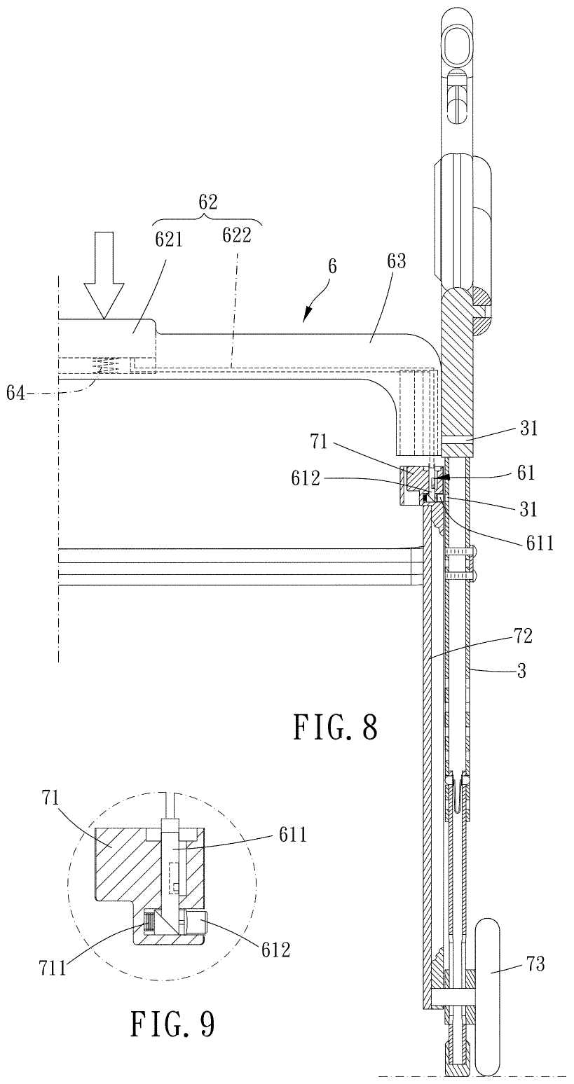

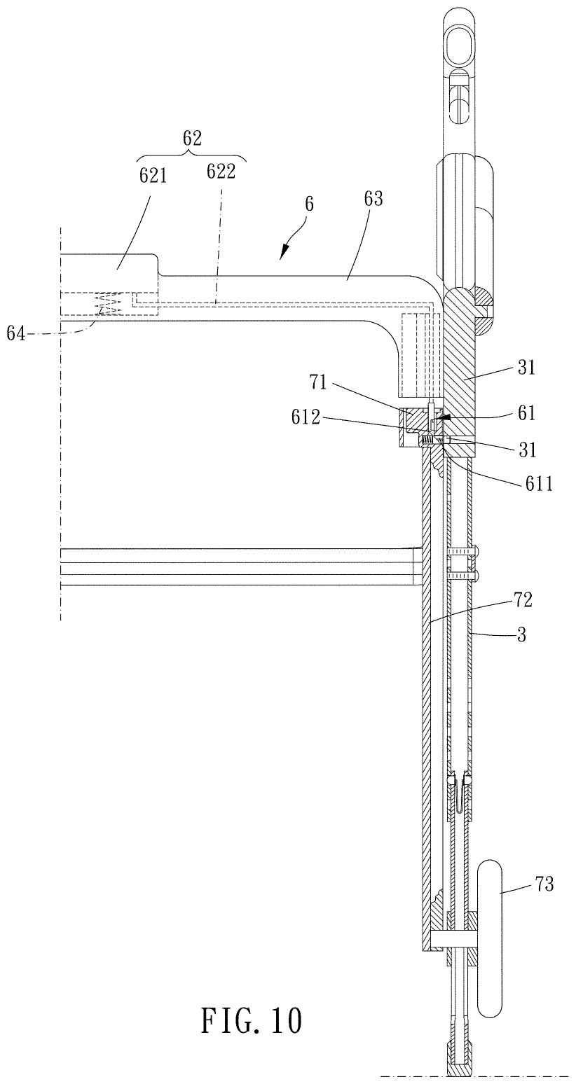

It is to be noted that the walking aid further includes a second adjusting assembly 6 and two wheel sets 7, the two wheel sets 7 are respectively slidably disposed on the two second legs 3 and include a wheel 73, the second adjusting assembly 6 includes two third abutting assemblies 61, the two third abutting assemblies 61 are respectively disposed on the two wheel sets 7, and the second adjusting assembly 6 is movable to be located in a third position or a fourth position. When the second adjusting assembly 6 is located in the third position, the third abutting assembly 61 abuts against the second leg 3 (as shown in FIGS. 6, 7 and 10), and the wheel set 7 is incapable of sliding relative to the second leg 3; when the second adjusting assembly 6 is located in the fourth position, the third abutting assembly 61 is disengaged from the second leg 3 (as shown in FIGS. 8 and 9), and the wheel set 7 is slidable relative to the second leg 3, so the user can adjust positions of the two wheel sets 7 relative to the two second legs 3 to make the two wheels 73 abut against a ground to push the walking aid with less effort (as shown in FIG. 6) or away from the ground to prevent the walking aid from sliding randomly (as shown in FIG. 10).

Preferably, the second adjusting assembly 6 further includes a control mechanism 62, the control mechanism 62 includes a pressing member 621 and two driving members 622, the two driving members 622 are respectively and co-movably connected to and between the two third abutting assemblies 61 and the pressing member 621, the pressing member 621 is movable to be located in the third position or the fourth position, and the two third abutting assemblies 61 can be driven by the two driving members 622 to be abuttable against the two second legs 3.

In this embodiment, each said third abutting assembly 61 further includes an actuating member 611 and a third abutting member 612, the two actuating members 611 are movable along an extension direction of the two second legs 3, the two third abutting members 612 are movable along a direction lateral to the extension direction of the two second legs 3, the two driving members 622 are co-movably connected to the two actuating members 611, each said actuating member 611 has a first inclined face 613, each said third abutting member 612 has a second inclined face 614 which abuts against one of the two first inclined faces 613, when the pressing member 621 is located in the third position, the two third abutting members 612 are inserted into the two second legs 3, and when the pressing member 612 moves toward the fourth position, the two first inclined faces 613 push the two second inclined faces 614 to make the two third abutting members 612 detached from the two second legs 3 so as to effectively control the two third abutting members 612 to be engaged with or detached from the two second legs 3.

Specifically, each said wheel set 7 includes a connecting base 71 and a connecting rod 72, one of two ends of the connecting rod 72 is connected to the connecting base 71, the other of the two ends of the connecting rod 72 is pivoted to the wheel 73, the two actuating members 611 and the two third abutting members 612 are respectively slidably disposed in the connecting base 71, each said connecting base 71 has a second elastic member 711, the second elastic member 711 normally biases the third abutting member 612 to move toward the second leg 3, the second adjusting assembly 6 further includes a connecting tube 63, and the pressing member 621 and the two driving members 622 are movably disposed in the connecting tube 63 to prevent the pressing member 621 and the driving members 622 from being exposed outside and accidentally falling off. In addition, the connecting tube 63 has a third elastic member 64, and the third elastic member 64 biases the pressing member 621 to make the pressing member 621 move away from the two connecting bases 71 to make the pressing member 621 to be located in the third position normally.

In this embodiment, each said driving member 622 is a S-shaped rod, and the connecting tube 63 is an upside-down U-shaped tube. Each said actuating member 611 has two hook members 615, each said connecting base 71 has two slots 712, and the two hook members 615 are respectively slidably positioned within the two slots 712 to prevent the actuating member 611 from being detached from the connecting base 71. In addition, the connecting tube 63 can be gripped to slide up or down relative to the second leg 3, and the two hook members 615 can drive the wheel set 7 to slide up or down. Preferably, each said second legs 3 has at least two restricting holes 31 which are arranged along a longitudinal direction, and the two third abutting members 612 are respectively insertable into one of the at least two restricting holes 31 of the two second legs 3 to fix the two wheel sets 7 in different heights.

Given the above, with the walking ad, the user does not need to crouch down or bend down to adjust the relative heights of the two first legs or the two second legs, and the two first cross cars and the two second cross bars are swingable relative to the two first legs and the two second legs to be quickly adjusted.

While we have shown and described various embodiments in accordance with the present invention, it should be clear to those skilled in the art that further embodiments may be made without departing from the scope of the present invention.

What is claimed is:

1. A walking aid, including:
a frame body, including two first legs which are parallel to each other and two second legs which are parallel to each other, each said first leg including a first pivoting portion;
a connecting assembly, including two first cross bars and two second cross bars, each said first cross bar including a second pivoting portion which is pivoted to the first pivoting portion, each said first cross bar being further pivoted to one of the two second legs, the two second cross bars being respectively pivoted to and between one of the two first legs and one of the two second legs;
two first adjusting assemblies, each said first adjusting assembly including a first abutting assembly and a second abutting assembly, each said first abutting assembly being disposed on one of the two first legs and movable to be located in a first position or a second position, each said second abutting assembly being disposed on one of the two first cross bars;
wherein when the two first abutting assemblies are located in the first position, the two first abutting assemblies respectively abut against the two second abutting assemblies, and the two first pivoting portions are unrotatable relative to the two second pivoting portions; when the two first abutting assemblies are located in the second position, the two first abutting assemblies are disengaged from the two second abutting assemblies, and the two first pivoting portions are rotatable relative to the two second pivoting portions.

2. The walking aid of claim 1, wherein each said first abutting assembly includes a first abutting member which is movably disposed on the first pivoting portion, each said second abutting assembly includes a plurality of second abutting members which are disposed on the second pivoting portion, and when each said first abutting assembly is located in the first position, the first abutting member of each said first abutting assembly is abuttable against one of the plurality of second abutting members of one of the two second abutting assemblies.

3. The walking aid of claim 2, wherein the plurality of second abutting members of each said second abutting assembly are annularly arranged on a plurality of recesses of an exterior circumferential wall of one of the two second pivoting portions, and the first abutting member is insertable into one of the plurality of recesses.

4. The walking aid of claim 3, wherein each said first pivoting portion is an exterior annular member, each said second pivoting portion is a pivoting block which is pivoted to and within the exterior annular member, and the plurality of recesses of each said second abutting assembly are disposed on an exterior circumferential wall of the pivoting block.

5. The walking aid of claim 1, wherein the first abutting assembly includes a first sliding member and a first adjusting member, the first sliding member is co-movably connected to and between the first abutting member and the first adjusting member, the first sliding member is arranged on the first leg, the first leg further has a first elastic member, the first elastic member normally biases the first sliding member to move toward the first position, and the first adjusting member is exposed within the first leg.

6. The walking aid of claim 1, further including a second adjusting assembly and two wheel sets, the two wheel sets being respectively slidably disposed on the two second legs and including a wheel, the second adjusting assembly including two third abutting assemblies, the two third abutting assemblies being respectively disposed on the two wheel sets, the second adjusting assembly being movable to be located in a third position or a fourth position; wherein when the second adjusting assembly is located in the third position, the third abutting assembly abuts against the second leg, and the wheel set is incapable of sliding relative to the second leg; when the second adjusting assembly is located in the fourth position, the third abutting assembly is disengaged from the second leg, and the wheel set is slidable relative to the second leg.

7. The walking aid of claim 6, wherein the second adjusting assembly further includes a control mechanism, the control mechanism includes a pressing member and two driving members, the two driving members are respectively and co-movably connected to and between the two third abutting assemblies and the pressing member, the pressing member is movable to be located in the third position and or fourth position, and the two third abutting assemblies can be driven by the two driving members to be abuttable against the two second legs.

8. The walking aid of claim 7, wherein each said third abutting assembly further includes an actuating member and a third abutting member, the two actuating members are movable along an extension direction of the two second legs, the two third abutting members are movable along a direction lateral to the extension direction of the two second legs, the two driving members are co-movably connected to the two actuating members, each said actuating member has a first inclined face, each said third abutting member has a second inclined face which abuts against one of the two first inclined faces, when the pressing member is located in the third position, the two third abutting members are inserted into the two second legs, and when the pressing member moves toward the fourth position, the two first inclined faces push the two second inclined faces to make the two third abutting members detached from the two second legs.

9. The walking aid of claim 8, wherein each said wheel set includes a connecting base and a connecting rod, one of two ends of the connecting rod is connected to the connecting base, the other of the two ends of the connecting rod is pivoted to the wheel, the two actuating members and the two third abutting members are respectively slidably disposed in the connecting base, each said connecting base has a second elastic member, the second elastic member normally biases the third abutting member to move toward the second leg, the second adjusting assembly further includes a connecting tube, and the pressing member and the two driving members are movably disposed in the connecting tube.

10. The walking aid of claim 4, wherein the first abutting assembly includes a first sliding member and a first adjusting member, the first sliding member is co-movably connected to and between the first abutting member and the first adjusting member, the first sliding member is arranged on the first leg, the first leg further has a first elastic member, the first elastic member normally biases the first sliding member to move toward the first position, and the first adjusting member is exposed within the first leg; the walking aid further includes a second adjusting assembly and two wheel sets, the two wheel sets are respectively slidably disposed on the two second legs and include a wheel, the second adjusting assembly includes two third abutting assemblies, the two third abutting assemblies are respectively disposed on the two wheel sets, and the second adjusting assembly is movable to be located in a third position or a fourth position; when the second adjusting assembly is located in the third position, the third abutting assembly abuts against the second leg, and the wheel set is incapable of sliding relative to the second leg; when the second adjusting assembly is located in the fourth position, the third abutting assembly is disengaged from the second leg, and the wheel set is slidable relative to the second leg; the second adjusting assembly further includes a control mechanism, the control mechanism includes a pressing member and two driving members, the two driving members are respectively and co-movably connected to and between the two third abutting assemblies and the pressing member, the pressing member is movable to be located in the third position or the fourth position, and the two third abutting assemblies can be driven by the two driving members to be abuttable against the two second legs; each said third abutting assembly further includes an actuating member and a third abutting member, the two actuating members are movable along an extension direction of the two second legs, the two third abutting members are movable along a direction lateral to the extension direction of the two second legs, the two driving members are co-movably connected to the two actuating members, each said actuating member has a first inclined face, each said third abutting member has a second inclined face which abuts against one of the two first inclined faces, when the pressing member is located in the third position, the two third abutting members are inserted into the two second legs, and when the pressing member moves toward the fourth position, the two first inclined faces push the two second inclined faces to make the two third abutting members detached from the two second legs; each said wheel set includes a connecting base and a connecting rod, one of two ends of the connecting rod is connected to the connecting base, the other of the two ends of the connecting rod is pivoted to the wheel, the two actuating members and the two third abutting members are respectively slidably disposed in the connecting base, each said connecting base has a second elastic member, the second elastic member normally biases the third abutting member to move toward the second leg, the second adjusting assembly further includes a connecting tube, and the pressing member and the two driving members are movably disposed in the connecting tube; each said driving member is a S-shaped rod, and the connecting tube is an upside-down U-shaped tube; a linkage rod integrally extends from the two second cross bars, and the linkage rod is laterally connected to the two second cross bars; each said actuating member has two hook members, each said connecting base has two slots, and the two hook members are respectively slidably positioned within the two slots; the connecting tube has a third elastic member, and the third elastic member biases the pressing member to make the pressing member move away from the two connecting bases; each said second legs has at least two restricting holes which are arranged along a longitudinal direction, and the two third abutting members are respectively insertable into one of the at least two restricting holes of the two second legs.
